(19) United States
(12) Patent Application Publication
(10) Pub. No.: US 2006/0136665 A1
(43) Pub. Date: Jun. 22, 2006

(54) Cyclically-interleaved access requests queuing method and system

(75) Inventor: Chih-Wei Chen, Taipei (TW)

Correspondence Address: PEARL COHEN ZEDEK, LLP, 1500 BROADWAY 12TH FLOOR, NEW YORK, NY, 10036, US

(73) Assignee: INVENTEC CORPORATION

(21) Appl. No.: 11/016,725

(22) Filed: Dec. 21, 2004

(51) Int. Cl. G06F 12/16

(52) U.S. Cl. 711/114

(57) ABSTRACT

A cyclically-interleaved access requests queuing method and system is proposed, which is designed for use in conjunction with an access control interface that is coupled between a computer system cluster (such as a server cluster) having multiple independent processing units and a data storage unit, and which is characterized by the use of a cyclically-interleaved queuing manner, rather than a sequential queuing manner, to queue the multiple sequences of access-request commands from the multiple processing units in the computer system cluster, which allows the overall access operations to the data storage unit to be more efficient than prior art.

### FIELD OF THE INVENTION

This invention relates to information technology (IT), and more particularly, to a cyclically-interleaved access requests queuing method and system which is designed for use in conjunction with an access control interface that is coupled between a computer system cluster having multiple independent processing units (such as a server cluster having multiple independent server units), and a data storage unit (such as a RAID unit, RAID=Redundant Array of Independent Disks), for providing a cyclically-interleaved queuing function for the multiple sequences of access requests issued from the multiple processing units in the computer system cluster, with the purpose of allowing the overall access operations to the data storage unit to be more efficient.

### BACKGROUND OF THE INVENTION

RAID (Redundant Array of Independent Disks) is a multi-disk storage unit that contains two or more hard disks, and which is commonly equipped to a network server to offer a very large data storage capacity.

In actual operation when a server wants to gain access to a RAID unit, the server issues an access request to the access control interface of the RAID unit to command the access control interface to perform the requested access operation. In practice, a RAID unit is typically shared by a server cluster (i.e., a cluster of independent server units), and therefore when these server units respectively issue a sequence of access requests to the RAID unit, it requires the RAID's access control interface to first put the commands of these access requests into a queue and then retrieve and process these queued access requests one by one in a predetermined order.

FIG. 1 is a schematic diagram showing an example of the data structure of a conventional queuing method for queuing multiple groups of access requests from multiple server units. In the example of FIG. 1, it is assumed that there is a server cluster including 3 server units: a first server unit, a second server unit, and a third server unit, and wherein the first server unit issues a sequence of 6 access-request commands respectively named [SERVER(1)_REQ(1), SERVER(1)_REQ(2), SERVER(1)_REQ(3), SERVER(1)_REQ(4), SERVER(1)_REQ(5), SERVER(1)_REQ(6)], subsequently the second server unit 12 issues a sequence of 4 access-request commands respectively named [SERVER(2)_REQ(1), SERVER(2)_REQ(2), SERVER(2)_REQ(3), SERVER(2)_REQ(4)], and subsequently the third server unit 13 issues one access-request command named [SERVER(3)_REQ(1)]. As shown in FIG. 1, by the conventional queuing method, these access-request commands are stored into one single FIFO (First In First Out) queue in the order of reception, and then retrieved one by one in FIFO manner for processing.

One drawback to the foregoing queuing method, however, is that since the command [SERVER(3)_REQ(1)] from the third server unit follows behind all of the other 10 commands from the first server unit and the second server unit, this command [SERVER(3)_REQ(1)] will be processed only after all the other 10 commands from the first server unit and the second server unit have been processed. As a consequence, the third server unit will wait for a very long time until it can gain access to the RAID unit. This drawback would undesirably degrade the efficiency of the overall access operations by the server cluster to the RAID unit.

### SUMMARY OF THE INVENTION

It is therefore an objective of this invention to provide a cyclically-interleaved access requests queuing method and system which allows the overall access operations by a server cluster to a data storage unit to be more efficient than prior art.

The cyclically-interleaved access requests queuing method and system according to the invention is designed for use in conjunction with an access control interface that is coupled between a computer system cluster having multiple independent processing units (such as a server cluster having multiple independent server units), and a data storage unit (such as a RAID unit), for providing a cyclically-interleaved queuing function for the multiple sequences of access requests issued from the multiple processing units in the computer system cluster, with the purpose of allowing the overall access operations to the data storage unit to be more efficient.

The cyclically-interleaved access requests queuing method and system according to the invention is characterized by the use of a cyclically-interleaved queuing manner, rather than a sequential queuing manner, to queue the multiple sequences of access-request commands from multiple server units, which allows the overall access operations to the data storage unit to be more efficient than the prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an example of the data structure of a FIFO queue utilized by a conventional queuing module for queuing multiple groups of access requests from multiple server units;

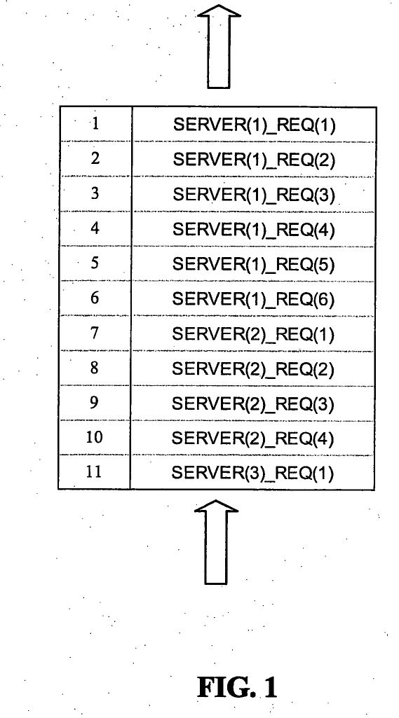

FIG. 2 is a schematic diagram showing the application architecture and object-oriented component model of the cyclically-interleaved access requests queuing system according to the invention; and

FIG. 3 is a schematic diagram showing an example of the data structure of a group of FIFO-type queuing buffers utilized by the cyclically-interleaved access requests queuing system according to the invention.

### DETAILED DESCRIPTION OF PREFERRED EMBODIMENTS

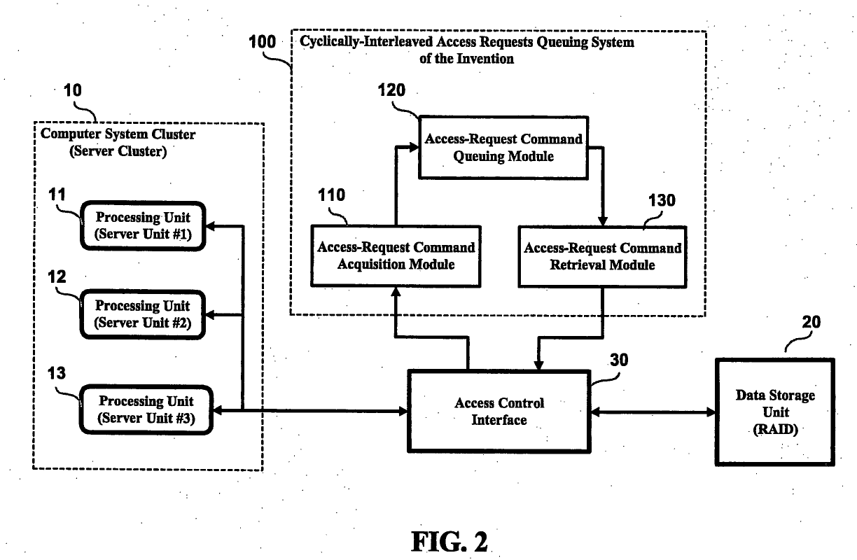

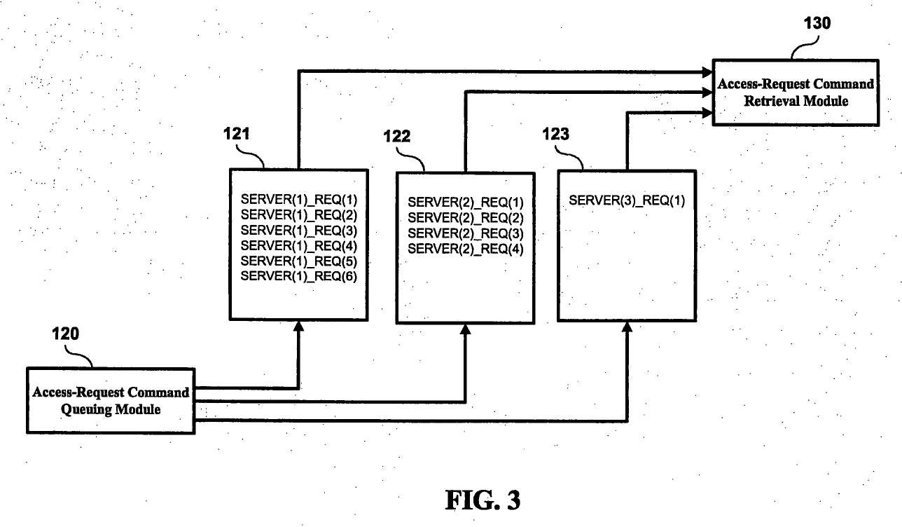

The cyclically-interleaved access requests queuing method and system according to the invention is disclosed in fill details by way of preferred embodiments in the following with reference to FIG. 2 and FIG. 3.

FIG. 2 is a schematic diagram showing the application architecture and object-oriented component model of the cyclically-interleaved access requests queuing system according to the invention (as the part enclosed in the dotted box indicated by the reference numeral 100). As shown, the cyclically-interleaved access requests queuing system of the invention 100 is designed for use in conjunction with an access control interface 30 that is coupled between a computer system cluster having multiple independent processing units (such as a server cluster 10 having multiple independent server units 11, 12, 13) and a data storage unit (such as a RAID unit). In the embodiment of FIG. 2, for example, the server cluster 10 includes only three server units 11, 12, 13 for demonstrative purpose only, but in practice, the applicable number of server units is unlimited). In practical implementation, for example, the access control interface 30 can be either an FC (Fibre Channel) compliant or an iSCSI (Internet SCSI, where SCSI=Small Computer System Interface) compliant interface.

As shown in FIG. 2, the object-oriented component model of the cyclically interleaved access requests queuing system of the invention 100 comprises: (a) an access-request command acquisition module 110; (b) an access-request command queuing module 120; and (c) an access-request command retrieval module 130.

The access-request command acquisition module 110 is coupled to the access control interface 30 for acquiring each access-request command received by the access control interface 30 from each of the server units 11, 12, 13 in the server cluster 10 and transferring each acquired access-request command to the access-request command queuing module 120.

The access-request command queuing module 120 includes a number of FIFO (First In First Out) type queuing buffers 121, 122, 123 as shown in FIG. 3, each being dedicatedly associated with one of the server units 11, 12, 13 in the server cluster 10 for storing every access-request command from the associated one of the server units 11, 12, 13, i.e., if an access-request command acquired by the access-request command acquisition module 110 was originated from the first server unit 11, it is stored into the first FIFO-type queuing buffer 121; if originated from the second server unit 12, it is stored into the second FIFO-type queuing buffer 122; and if originated from the third server unit 13, it is stored into the third FIFO-type queuing buffer 123.

The access-request command retrieval module 130 is capable of retrieving the access-request commands stored in the FIFO-type queuing buffers 121, 122, 123 one by one in a cyclically-interleaved FIFO manner and sending each retrieved access-request command to the access control interface 30 for the access control interface 30 to process the retrieved access-request command.

In the following example, it is assumed that the first server unit 11 in the server cluster 10 issues a sequence of 6 access-request commands [SERVER(1)_REQ(1), SERVER(1)_REQ(2), SERVER(1)_REQ(3), SERVER(1)_REQ(4), SERVER(1)_REQ(5), SERVER(1)_REQ(6)], subsequently the second server unit 12 issues a sequence of 4 access-request commands [SERVER(2)_REQ(1), SERVER(2)_REQ(2), SERVER(2)_REQ(3), SERVER(2)_REQ(4)], and subsequently the third server unit 13 issues one access-request command [SERVER(3)_REQ(1)].

Referring to FIG. 2 together with FIG. 3, in actual operation when the access control interface 30 receives the above-listed 3 sequences of access-request commands from the 3 server units 11, 12, 13 in the server cluster 10, the access-request command acquisition module 110 will promptly acquire these access-request commands and transfer these access-request commands to the access-request command queuing module 120, where these access-request commands are stored respectively into the FIFO-type queuing buffers 121, 122, 123 based on their originated server units 11, 12, 13 as illustrated in FIG. 3, i.e., the first sequence of access-request commands [SERVER(1)_REQ(1), SERVER(1)_REQ(2), SERVER(1)_REQ(3), SERVER(1)_REQ(4), SERVER(1)_REQ(5), SERVER(1)_REQ(6)] originated from the first server unit 11 are stored into the first FIFO-type queuing buffer 121, the second sequence of access-request commands [SERVER(2)_REQ(1), SERVER(2)_REQ(2), SERVER(2)_REQ(3), SERVER(2)_REQ(4)] originated from the second FIFO-type queuing buffer 122 are stored into the second FIFO-type queuing buffer 122, and the access-request command [SERVER(3)_REQ(1)] originated from the third server unit 13 is stored into the third FIFO-type queuing buffer 123.

When the access control interface 30 is ready to process an access-request command, the access-request command retrieval module 130 will responsively retrieve the access-request commands stored in the FIFO-type queuing buffers 121, 122, 123 one by one in a cyclically-interleaved FIFO manner and then send each retrieved access-request command to the access control interface 30 for the access control interface 30 to process the retrieved access-request command, i.e., the access-request command retrieval module 130 first retrieves the topmost queued item SERVER(1)_REQ(1) from the first FIFO-type queuing buffer 121 and sends it to the access control interface 30 for processing; then after the access control interface 30 finishes processing this command SERVER(1)_REQ(1), the access-request command retrieval module 130 retrieves the topmost queued item SERVER(2)_REQ(1) from the second FIFO-type queuing buffer 122 and send it to the access control interface 30 for processing; and then after the access control interface 30 finishes processing this command SERVER(2)_REQ(1), the access-request command retrieval module 130 retrieves the topmost queued item SERVER(3)_REQ(1) from the third FIFO-type queuing buffer 123 and send it to the access control interface 30 for processing. After the access control interface 30 finishes processing this command SERVER(3)_REQ(1), the access-request command retrieval module 130 returns cyclically back to the first FIFO-type queuing buffer 121 to retrieve the next queued item SERVER(1)_REQ(2); and so forth, until all of the access-request commands in the FIFO-type queuing buffers 121, 122, 123 have been emptied.

Compared to prior art, the access-request command retrieval module 130 is able to retrieve the command SERVER(3)_REQ(1) originated from the third server unit 13 at the third retrieval action, whereas the prior art will do so at the 11th retrieval action. Therefore, the cyclically-interleaved and time-shared retrieval method allows the overall access operations to the data storage unit 20 to be more efficient than the prior art.

In conclusion, the invention provides a cyclically-interleaved access requests queuing method and system for use in conjunction with an access control interface that is coupled between a computer system cluster including multiple independent processing units (such as a server cluster including multiple independent server units) and a data storage unit (such as a RAID unit), and which is characterized by the use of a cyclically-interleaved queuing manner, rather than a sequential queuing manner, to queue the multiple sequences of access-request commands from the multiple processing units in the computer system cluster, which allows the overall access operations to the data storage unit to be more efficient than the prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A cyclically-interleaved access requests queuing method for use on an access control interface that is coupled between a data storage unit and a computer system cluster having multiple independent processing units for providing a cyclically-interleaved queuing function for queuing the multiple sequences of access request commands from the multiple processing units in the computer system cluster;
the cyclically-interleaved access requests queuing method comprising:
in the access control interface, building a number of FIFO-type queuing buffers, each being dedicatedly associated with one of the processing units in the computer system cluster;
in actual operation,
acquiring each access-request command received by the access control interface from each of the processing units in the computer system cluster;
storing each acquired access-request command into the associated one of the FIFO-type queuing buffers that is dedicated to the processing unit where the acquired access-request command is originated;
retrieving the access-request commands stored in the FIFO-type queuing buffers one by one in a cyclically-interleaved FIFO manner; and
sending each retrieved access-request command to the access control interface for the access control interface to process the retrieved access-request command.

2. The cyclically-interleaved access requests queuing method of claim 1, wherein the computer system cluster is a server cluster, and the multiple processing units therein are each a server unit.

3. The cyclically-interleaved access requests queuing method of claim 1, wherein the data storage unit is a RAID (Redundant Array of Independent Disks) unit.

4. The cyclically-interleaved access requests queuing method of claim 1, wherein the access control interface is an FC (Fibre Channel) compliant interface.

5. The cyclically-interleaved access requests queuing method of claim 1, wherein the access control interface is an iSCSI (Internet Small Computer System Interface) compliant interface.

6. A cyclically-interleaved access requests queuing system for use with an access control interface that is coupled between a data storage unit and a computer system cluster having multiple independent processing units for providing a cyclically-interleaved queuing function for queuing the multiple sequences of access request commands from the multiple processing units in the computer system cluster;
the cyclically-interleaved access requests queuing system comprising:
an access-request command acquisition module, which is capable of acquiring each access-request command received by the access control interface from each of the processing units in the computer system cluster;
an access-request command queuing module, which includes a number of FIFO-type queuing buffers, each being dedicatedly associated with one of the processing units in the computer system cluster for storing every access-request command from the associated one of the processing units; and
an access-request command retrieval module, which is capable of retrieving the access-request commands stored in the FIFO-type queuing buffers one by one in a cyclically-interleaved FIFO manner, and sending each retrieved access-request command to the access control interface for the access control interface to process the retrieved access-request command.

7. The cyclically-interleaved access requests queuing system of claim 6, wherein the computer system cluster is a server cluster, and the multiple processing units therein are each a server unit.

8. The cyclically-interleaved access requests queuing system of claim 6, wherein the data storage unit is a RAID (Redundant Array of Independent Disks) unit.

9. The cyclically-interleaved access requests queuing system of claim 6, wherein the access control interface is an FC (Fibre Channel) compliant interface.

10. The cyclically-interleaved access requests queuing system of claim 6, wherein the access control interface is an iSCSI (Internet Small Computer System Interface) compliant interface.
